(19) United States
(12) Patent Application Publication
(10) Pub. No.: US 2008/0089548 A1
(43) Pub. Date: Apr. 17, 2008

(54) ALL-IN-ONE HOME THEATER SYSTEM

(76) Inventor: Daniel Huang, El Monte, CA (US)

Correspondence Address: LOZA & LOZA LLP, 305 N. Second Avenue, #127, Upland, CA, 91786-6064, US

(21) Appl. No.: 11/866,400

(22) Filed: Oct. 2, 2007

Related U.S. Application Data
(60) Provisional application No. 60/829,058, filed on Oct. 11, 2006.

(51) Int. Cl. H04R 1/02

(52) U.S. Cl. 381/388

(57) ABSTRACT

An all-in-one home theater system is provided having an enclosure that houses a plurality of integrated speakers configured to provide a surround sound effect and an integrated docking station for receiving a mobile electronic device. A built-in processing circuit, also housed by the home theater device enclosure, may be configured to receive audio and/or video signals from the mobile electronic device coupled to the docking station and send the video signals to an external display screen and the audio signals to the integrated speakers. The integrated processing circuit may be configured to generate a menu of content stored in the mobile electronic device, and display the menu on the external display device. A remote control device may allow a user to select content stored in the mobile electronic device from the menu displayed on the external display device.

### CROSS-REFERENCE TO RELATED APPLICATIONS

This non-provisional U.S. Patent Application claims priority, under 35 U.S.C. § 120, to the U.S. Provisional Patent Application No. 60/829,058 to Daniel Huang, filed on Oct. 11, 2006 which is incorporated by reference herein.

### FIELD

One embodiment relates to audio speakers and, more particular, to a speaker device housing a plurality of speakers to create a home theater system effect on a single enclosure and having an integrated docking station for an audio/video storage device.

### BACKGROUND

Home theater speakers have become increasingly popular. In many cases, a home is not fitted for built-in speakers. In such instances, a user may position exposed speakers throughout a room to create a home theater environment. Speaker wires may need to be run to the speakers in a manner that the wires are exposed. However, such exposed speakers and wires are not aesthetically pleasing.

Moreover, personal digital players, such as the iPod™ by Apple Inc., have become widely used to store and playback music and video. However, there is no existing way to easily integrate these devices into an existing home audio/video system.

Therefore, a way is needed to provide an easy-to-install, aesthetic, home theater speaker system while providing a way to easily integrate personal digital players into existing home audio/video systems.

### SUMMARY

Various embodiments of the invention are directed toward a speaker device housing a plurality of speakers for providing a home theater effect within a single enclosure.

An all-in-one home theater device is provided having an elongated enclosure housing a plurality of speakers. A mobile device input/output interface is provided including a built-in docking station for receiving a mobile electronic device. A processing circuit is housed within the elongated enclosure and coupled to the mobile device input/output interface and the plurality of speakers. The processing circuit may be configured to retrieve audio content from a mobile electronic device (coupled to the docking station) and play the audio content through the plurality of speakers. The plurality of speakers may be configured to provide a surround sound effect. The mobile electronic device may include integrated content storage and playback capabilities.

The processing circuit may be further configured to display a user interface through an external display device through which content stored in the mobile electronic device can be selected for playback. The processing circuit may also be configured to (a) retrieve audio content information from the mobile electronic device, (b) generate a menu of the audio content information, and (c) send the menu to an external display device coupled to the processing circuit.

In another example, the processing circuit may be further configured to (a) receive a menu selection identifying a particular audio content, (b) retrieve the selected audio content from the mobile electronic device, and (c) play the retrieved audio content through the plurality of speakers.

In yet another example, the processing circuit is further configured to (a) retrieve video content information from the mobile electronic device, (b) generate a menu of the video content information, (c) send the menu to an external display device coupled to the processing circuit, (d) receive a menu selection identifying a particular video content, (e) retrieve the selected video content from the mobile electronic device, and (f) display the retrieved video content through the external display device.

The all-in-one home theater device may also include a remote control configured to communicate with the processing circuit to allow a user to select audio content to be played from the mobile electronic device. The remote control may be further configured to communicate with the processing circuit to allow the user to select audio content to be stored in the mobile electronic device. The remote control may also be configured to control the volume for the plurality of speakers.

The all-in-one home theater device may also include a network interface coupled to the processing circuit, wherein the processing circuit is further configured to (a) receive audio and video content through the network interface, (b) play the audio content through the plurality of speakers, and (c) display the video content through the external display device.

A media player may also be housed within the elongated enclosure and coupled to the processing circuit. The processing circuit may be configured to (a) retrieve audio and video content from the media player, (b) play the audio content through the plurality of speakers, and (c) display the video content through the external display device.

A method operational on an all-in-one home theater device is also provided having built-in speakers and a docking station for mobile electronic devices. Content information is retrieved from a mobile electronic device coupled to the docking station. A menu of the content information is generated and sent to an external display device. A menu selection may be received identifying a selected content. The selected content is retrieved from the mobile electronic device. A video content portion of the retrieved selected content is displayed through the external display device. An audio content portion of the retrieved selected content is played through the built-in speakers.

The method may also include obtaining audio and video content through a built-in network interface. The audio content is then played through the plurality of speakers while the video content is displayed through the external display device.

The method may also include obtaining audio and video content from an internal or external media player. The audio content is played through the plurality of speakers while the video content is displayed through the external display device.

An all-in-one home theater device is also provided including (a) means for retrieving content information from a mobile electronic device, (b) means for generating a menu of the content information, (c) means for sending the menu to an external display device, (d) means for receiving a menu selection identifying a selected content, (e) means for retrieving the selected content from the mobile electronic device, and (f) means for playing an audio content portion of the retrieved selected content. The all-in-one home theater device may also include (a) means for obtaining an audio and video content through a built-in network interface, and (b) means for storing the audio and video content on the mobile electronic device. The all-in-one home theater device may also include (a) means for obtaining audio and video content from an integrated or external media player, (b) means for playing the audio content, and (c) means for displaying the video content through the external display device.

### BRIEF DESCRIPTION OF THE DRAWINGS

FIG. 1 illustrates a front perspective view of one example of the all-in-one home theater device.

FIG. 2 illustrates a rear perspective view of one example of the all-in-one home theater device.

FIG. 3 is a block diagram illustrating the components of an all-in-one home theater device according to one example.

FIG. 4 is a block diagram illustrating a detailed example of an all-in-one home theater device according to one implementation.

FIG. 5 is a block diagram illustrating the functional components of an all-in-one home theater device to playback content from an audio/video storage device according to one example.

FIG. 6 is a diagram illustrating the flow of information in the operation of the all-in-one home theater device of FIG. 5 according to one example.

FIG. 7 is a block diagram illustrating the functions performed by an all-in-one home theater device to store content to an external audio/video electronic device according to one example.

FIG. 8 is a diagram illustrating the flow of information in the operation of the all-in-one home theater device of FIG. 7 according to one example.

FIG. 9 is a flow diagram illustrating a method operational on an all-in-one home theater device according to one implementation.

### DETAILED DESCRIPTION

In the following detailed description of the invention, numerous specific details are set forth in order to provide a thorough understanding of the invention. However, the invention may be practiced without these specific details. In other instances, well known methods, procedures, and/or components have not been described in detail so as not to unnecessarily obscure aspects of the invention.

Also, it is noted that the examples may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Furthermore, various configurations may be implemented by hardware, software, firmware, middleware, microcode, or a combination thereof. When implemented in software, firmware, middleware, or microcode, the program code or code segments to perform the described tasks may be stored in a computer-readable medium such as a storage medium or other storage means. A processor may perform the defined tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, and the like, may be passed, forwarded, or transmitted via a suitable means including memory sharing, message passing, token passing, and network transmission, among others. The methods disclosed herein may be implemented in hardware, software, or both.

If functions are implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Moreover, a storage medium may represent one or more devices for storing data, including read-only memory (ROM), random access memory (RAM), magnetic disk storage mediums, optical storage mediums, flash memory devices, and/or other computer-readable mediums for storing information.

The various illustrative functions, logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

In the following description, certain terminology is used to describe certain features of one or more embodiments of the invention. For instance, the term “audio/video electronic device” refers to any electronic device capable of storing a plurality of audio and/or video content. A “mobile electronic device” refers to any electronic device having a compact size and capable of storing audio/video content on-board and playing the stored audio/video content. Such electronic devices may have a built-in power source (e.g., batteries) and are often used to store large amounts of music, video, and/or other types of data.

One embodiment provides an all-in-one home theater device having an enclosure that houses a plurality of integrated speakers configured to provide a surround sound effect and an integrated docking station for receiving an audio/video mobile electronic device (e.g., iPod™) and transferring audio/video content to/from the mobile electronic device.

A built-in processing circuit, also housed by the home theater device enclosure, may be configured to receive audio and/or video signals from the mobile electronic device coupled to the docking station and send the video signals to an external display screen, for example a television, and the audio signals to the integrated speakers. The built-in processing circuit may be configured to generate a menu of content stored in the mobile electronic device, and display the menu on the external display device. A remote control device may be provided to allow a user to control the operations of the all-in-one home theater device and/or content selection. For example, the remote control may be configured to allow a user to select content stored in the mobile electronic device from a menu displayed on the external display device. In this manner, the all-in-one home theater device facilitates playback of audio/video content from the mobile electronic device through the external display device and/or integrated speakers.

Moreover, a disc player/writer, TV or radio receiver, or DVR may be coupled to the all-in-one home theater device or may be integrated therein. The all-in-one home theater device may further be configured to receive audio and/or video signals from a local area network or the Internet to be sent to the plurality of speakers and/or the external display screen. The processing circuit may also be configured to use the mobile electronic device as a digital music/video recorder by storing audio and/or video content to it from a disc, cable, satellite feed, and/or network connection.

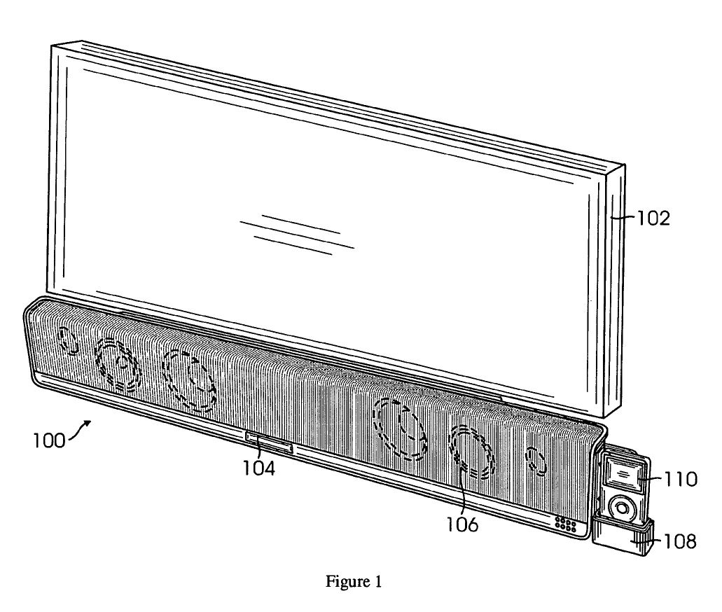

FIG. 1 illustrates a front perspective view of one example of an all-in-one home theater device 100. The all-in-one home theater device 100 may have an elongated enclosure 104 configured to be mounted length-wise, below or above, and adjacent to an external display device 102. The external display device 102 may be a large-size display screen, such as a television set, plasma screen, projection screen, etc.

The all-in-one home theater device 100 may include a plurality of speakers 106 of different sizes and/or configurations housed within the elongated enclosure 104. The plurality of speakers 106 may include tweeters, midrange, woofers, subwoofers, etc., configured to provide a surround sound effect. For example, the plurality of speakers 106 may be configured in a 2 channel, 2.1 channel, 5.1 channel, or 7.1 channel surround sound configuration.

The all-in-one home theater device 100 may also include an integrated docking station 108 on which to dock an audio/video mobile electronic device 110, such as an iPod™. The docking station 108 may slide out of the enclosure 104, to allow docking or removal of the audio/video mobile electronic device 110, or slide into the enclosure 104 to conceal the docking station 108. Alternatively, the docking station 108 may fold from a first concealed position into a second accessible position. The docking station 108 may serve to hold the audio/video mobile electronic device 110 so that audio and/or video content may be retrieved and/or stored by the all-in-one home theater device 100. The audio/video mobile electronic device 110 may be a portable or mobile media player such as an iPod™, a portable hard drive, a USB storage device, a flash memory, and/or other device capable of storing audio and/or video content in analog and/or digital formats.

In one embodiment, the all-in-one home theater device 100 may include an integrated digital player/recorder. For example, the all-in-one home theater device 100 may have a CD, DVD, or DVR player/recorder integrated within the enclosure 104. The all-in-one home theater device 100 may also include an integrated signal receiver to receive analog and/or digital cable and/or satellite signals.

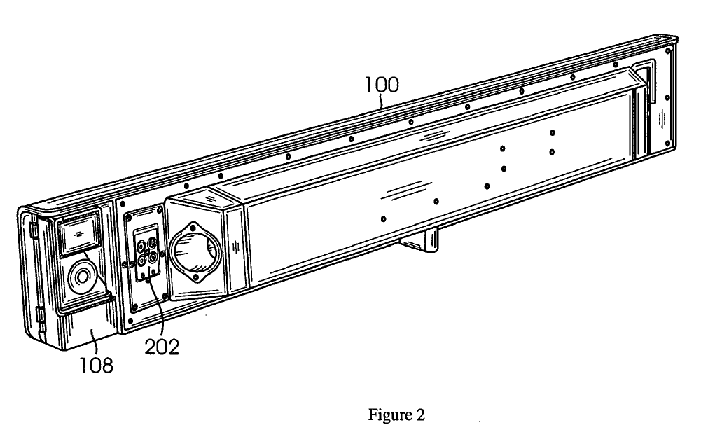

FIG. 2 illustrates a rear perspective view of one example of the all-in-one home theater device 100. This example shows the docking station 108 in a retracted or stored position so that, when the all-in-one home theater device 100 is installed on a wall, the docking station 108 is concealed from view. The all-in-one home theater device 100 may also include an input/output interface 202 which may be used to couple to the external display device 102, an external audio/video source, and/or an external audio/video playback/recording device.

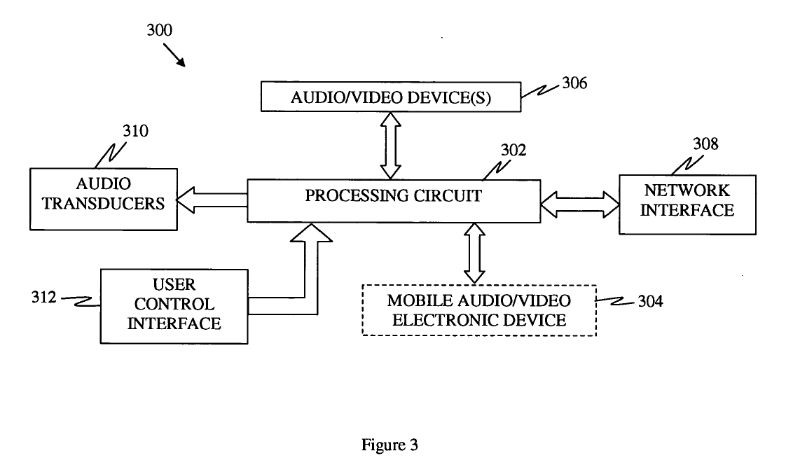

FIG. 3 is a block diagram illustrating the components of an all-in-one home theater device 300 according to one example. The all-in-one home theater device 300 may include a processing or control circuit 302 configured to control the operation of the device 300. The processing circuit 302 may obtain, process and/or send audio and/or video content to and from an external mobile electronic device 304 coupled to a docking station integrated into the all-in-one home theater device 300. The processing circuit 302 may also obtain, process and/or send audio and/or video content to and/or from other external or integrated audio/video devices 306 and/or via a network interface 308.

The processing circuit 302 may output audio content to integrated (i.e., built-in) audio transducers 308 (e.g., speakers) and/or output video/audio content to the external or integrated audio/video devices 306.

In various implementations, the processing circuit 302 may be implemented by a processor, a controller, a plurality of processors, and/or a combination of other electronic devices executing instructions to move audio and/or video content among different interfaces. In one example, the processing circuit 302 may be configured to retrieve audio/video content information (e.g., a list of content items) stored in the mobile electronic device 304. The processing circuit 302 then generates a menu of the available content and displays it on a video display device 306. A user control interface 312 allows a user to select one or more audio/video content items from the generated menu. The user control interface 312 may include a remote control that wirelessly communicates with the processing circuit 302 to allow a user to operate the all-in-one home theater device 300. The user control interface 312 may also include integrated buttons (e.g., keypad, touchpad, etc.) with which to provide input to the processing circuit 302. Once a user selects audio/video content, the processing circuit 302 retrieves the selected content from the mobile electronic device 304 and plays it through the audio transducers 310 (e.g., speakers) and/or video device 306 (e.g., television). Similarly, the processing circuit 302 may obtain content information (e.g., content list) and retrieve selected content from the network interface 308 or other sources. Additionally, the processing circuit 302 may store audio/video content to the mobile electronic device 304 or other audio/video devices 306.

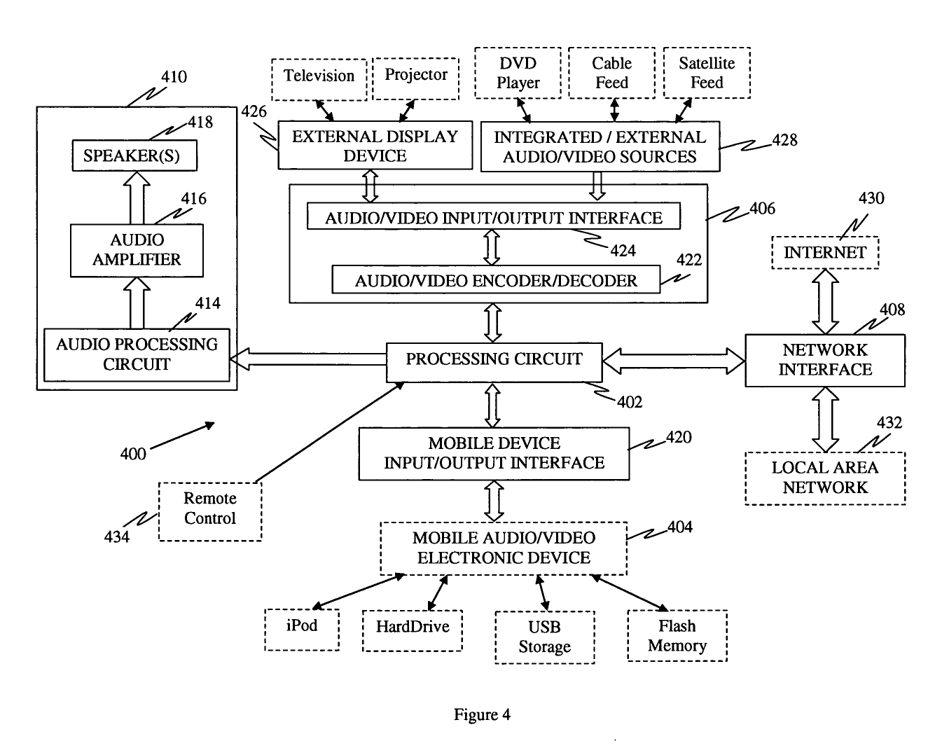

FIG. 4 is a block diagram illustrating a detailed example of an all-in-one home theater device 400 according to one implementation. A control circuit or processing circuit 402 is coupled to an integrated audio transducer 410 that may include an audio processing circuit 412, and audio amplifier 416, and one or more speakers 418. The audio processing circuit 414 may convert digital signals to analog signals that are then amplified by the audio amplifier 416 before being passed to the integrated speakers 418.

An integrated audio/video device 406 may include an audio/video encoder/decoder 422 coupled to an audio/video input/output interface 424 through which the processing circuit 402 may send video signals to an external display device 426, such as a television set or projector. Similarly, the processing circuit 402 may receive audio and/or video signals from integrated and/or external audio/video sources 428, such as a DVD player, cable feed, satellite feed, and/or DVR. Likewise, the integrated audio/video device 406 may allow the processing circuit 402 to send audio/video signals to integrated and/or external audio/video devices.

An integrated mobile device input/output interface 420 may also be coupled to the processing circuit 402. The mobile device input/output interface 420 may include a docking station on which a audio/video mobile electronic device 404 may be docked, thereby allowing the processing circuit 402 to retrieve and/or store audio/video content to the docked audio/video mobile electronic device 404. In various examples, the audio/video mobile electronic device 404 may be an iPod™, a harddrive, a USB storage device, and/or a flash memory device.

The processing circuit 402 may be configured to use the external display device 426 as a visual interface from which a user can select options and/or content to play and/or record via a remote control 434. For example, the processing circuit 402 may extract menu options and/or a content list from a audio/video mobile electronic device 404, display the menu options and/or content list on the external display device 426, and allow a user to select menu options and/or content via the remote control 434. The remote control 434 may be configured to operate with the processing circuit 402 to select content to be played and/or recorded, the source and/or destination of the content, and/or control the volume of content being played.

In an alternative implementation, a user may select audio/video content through a user interface on the audio/video mobile electronic device 404. That is, while the mobile electronic device 404 is inserted in the docking station of the mobile device input/output interface 420, a user may use its integrated interface (e.g., the buttons on the mobile electronic device 404) to select the audio/video content to be played by the all-in-one home theater device 400.

The all-in-one home theater device 400 may also include a network interface 408 coupled to the processing circuit 402 to obtain audio/video content from the internet 430 or a local area network 432. For example, the processing circuit 402 may retrieve and/or process audio/video content from the network interface 408 and send it to the mobile electronic device 404, the integrated or external audio/video devices 406, and/or the audio transducer 410. Similarly, the processing circuit 402 may obtain and/or process audio/video content from the mobile electronic device 404, the audio/video devices 406, and/or the audio transducer 410 and send it through the network interface 408. The network interface 408 may also serve to receive software updates to adjust and/or modify the operation and/or features of the all-in-one home theater device 400. For example, the all-in-one home theater device 400 may be configured to receive atomic clock updates via the network interface 408.

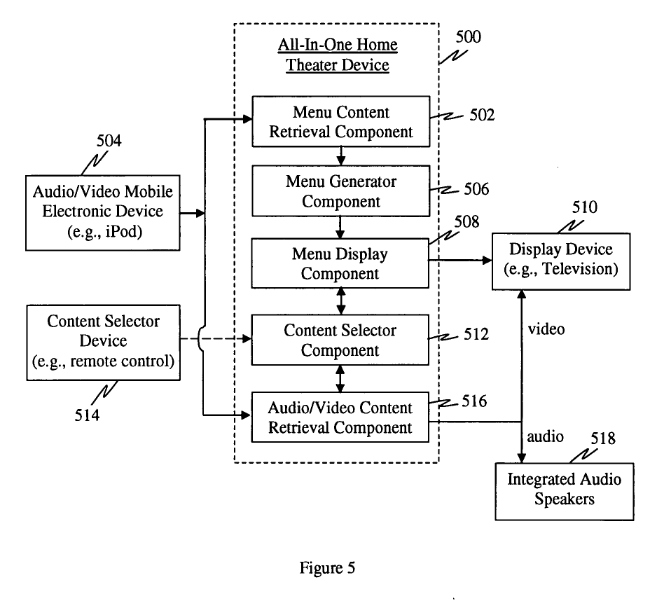

FIG. 5 is a block diagram illustrating the functional components of an all-in-one home theater device 500 to playback content from an audio/video mobile electronic device 504 according to one example. A menu content retrieval component 502 retrieves a list of audio/video content from an external audio/video mobile electronic device 504, such as a mobile digital audio/video player (e.g., iPod™). A menu generator component 506 then generates a menu from the information retrieved. A menu display component 508 then sends the generated menu to an external display device 510 where a user can view the available audio/video content menu. A content selector component 512 receives signals from a content selector device 514 to select a content item from the generated menu. The selected content item is then retrieved by an audio/video content retrieval component 516 which sends the retrieved audio content to integrated audio speakers 518 and video content to the display device 510 for playback. Communications to and from the audio/video mobile electronic device 504 may be performed using a communication protocol provided by the electronic device 504 to access, retrieve and/or store content therein. Thus, the all-in-one home theater device 500 may be configured to identify the presence and type of audio/video mobile electronic device 504 and use the appropriate protocol to communicate with the electronic device 504.

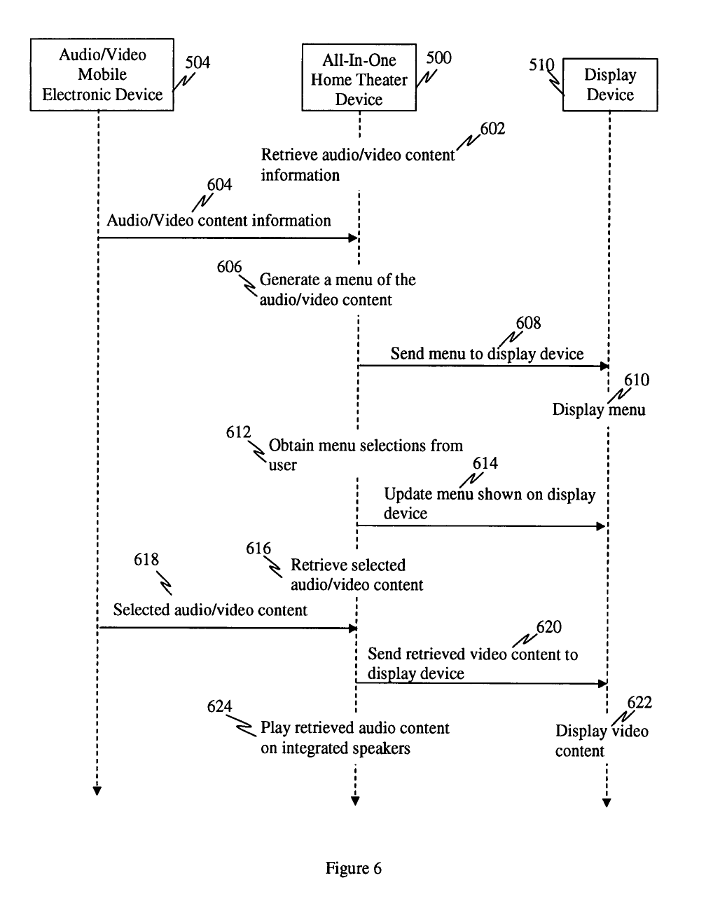

FIG. 6 is a diagram illustrating the flow of information in the operation of the all-in-one home theater device 500 of FIG. 5 according to one example. The all-in-one home theater device initiates retrieval of audio/video content information 602 from the audio/video electronic device 504. The audio/video electronic device 504 sends the audio/video content information 604 to the all-in-one home theater device 500. The audio/video content information may include the titles of audio and/or video content stored in the audio/video electronic device 504. The all-in-one home theater device 500 then generates a menu of the retrieved audio/video content 606 and sends the menu to an external display device 608 where it is displayed 610. The all-in-one home theater device 500 then obtains a menu selection from the user 612. The menu shown on the display device may be updated based on the user selection 614. The all-in-one home theater device 500 then initiates the retrieval of the selected audio/video content 616. The audio/video electronic device 504 sends the selected audio/video content 618 to the all-in-one home theater device 500. The all-in-one home theater device 500 then sends the retrieved video content to the external display device 620 where it is displayed 622. The all-in-one home theater device 500 plays the retrieved audio content on the integrated speakers 624.

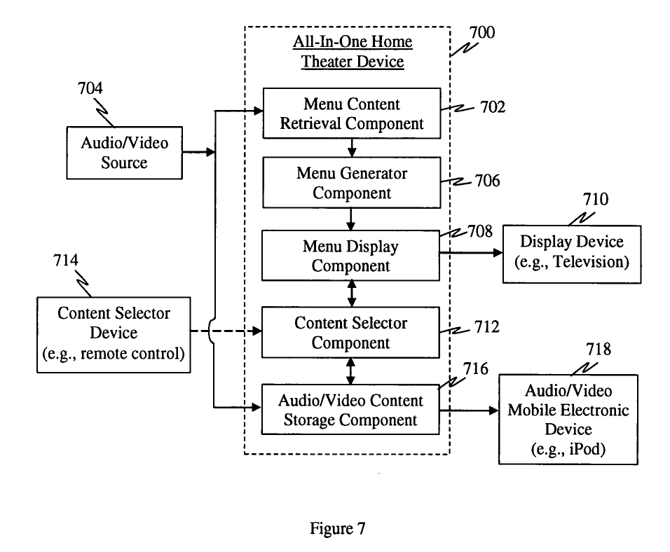

FIG. 7 is a block diagram illustrating the functions performed by an all-in-one home theater device 700 to store content to an external audio/video electronic device according to one example. A menu content retrieval component 702 retrieves a list of audio/video content from an external or integrated audio/video source 704, such as a cable feed, satellite feed, DVD player, etc. A menu generator component 706 then generates a menu from the information retrieved. A menu display component 708 then sends the generated menu to an external display device 710 where a user can view the available audio/video content menu. A content selector component 712 receives signals from a content selector device 714 to select a content item from the generated menu. The selected content item (e.g., music, movie, video game, etc.) is then retrieved by an audio/video content retrieval component 716 which sends the retrieved content to an external audio/video mobile electronic device 718, such as a mobile digital audio/video player (e.g., iPod™) that may be coupled to an integrated docking station.

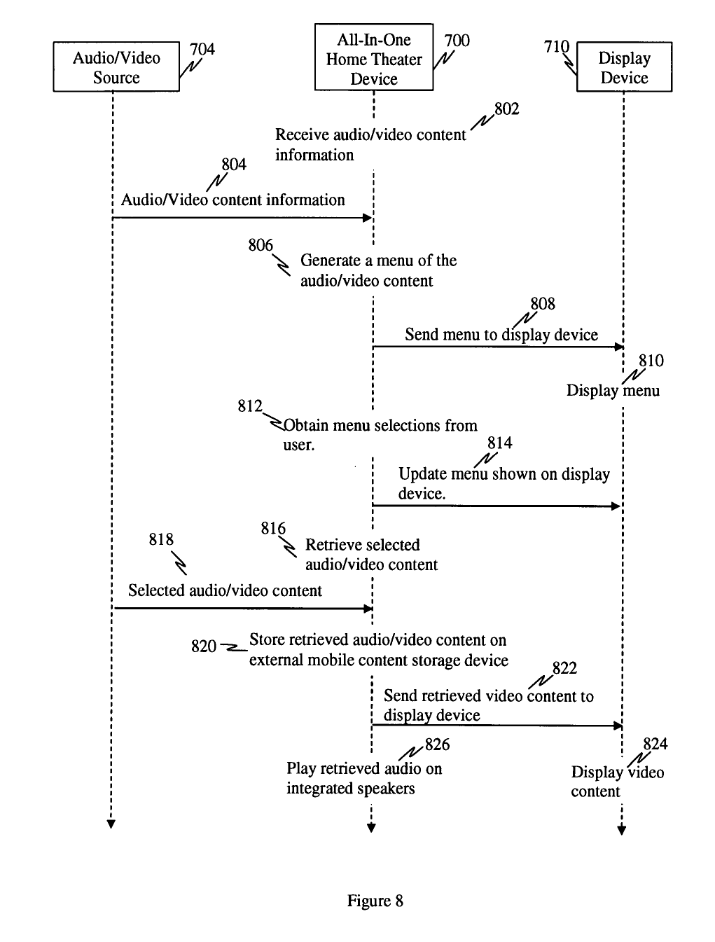

FIG. 8 is a diagram illustrating the flow of information in the operation of the all-in-one home theater device 700 of FIG. 7 according to one example. The all-in-one home theater device 700 initiates retrieval of audio/video content information 802 from an external or integrated audio/video source 704. The audio/video source 704 sends the audio/video content information 804 to the all-in-one home theater device 700. The audio/video content information may include the titles of audio and/or video content available from the audio/video source 704. The all-in-one home theater device 700 then generates a menu of the retrieved audio/video content 806 and sends the menu to an external display device 808 where it is displayed 810. The all-in-one home theater device 700 then obtains a menu selection from the user 812. The menu shown on the display device may be updated based on the user selection 814. The all-in-one home theater device 700 then initiates the retrieval of the selected audio/video content 816. The audio/video source 704 sends the selected audio/video content 818 to the all-in-one home theater device 700. The all-in-one home theater device 700 may then store the retrieved audio/video content on an external mobile content storage device 820 (e.g., mobile electronic device, personal digital player/recorder, such as iPod™). The retrieved video content may also be sent to the external display device 822 where it is displayed 824. The all-in-one home theater device 700 may also play the retrieved audio content on integrated speakers 826.

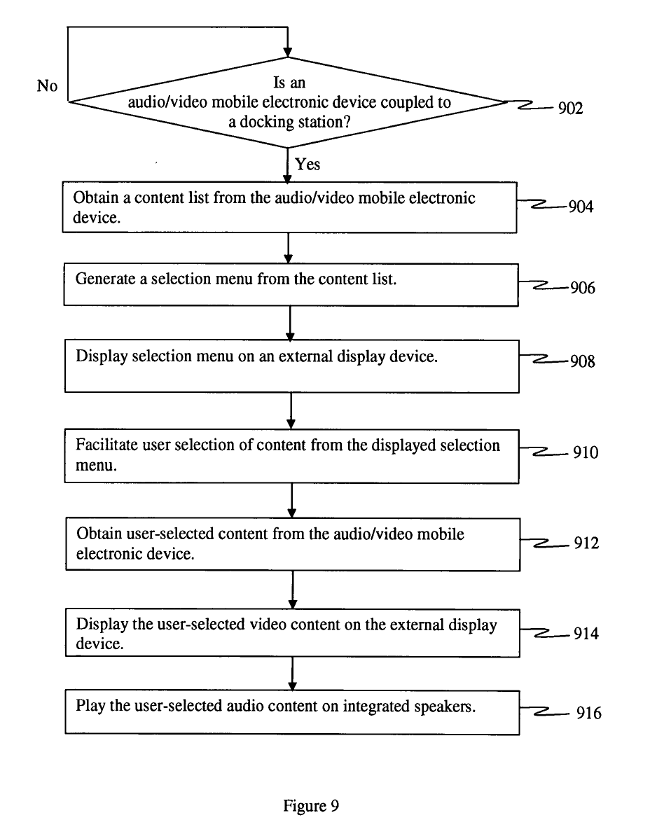

FIG. 9 is a flow diagram illustrating a method operational on an all-in-one home theater device according to one implementation. The all-in-one-home theater device may include integrated speakers and a docking station to receive a mobile electronic device, such as an iPod™ music and/or video player. The all-in-one-home theater device detects when a mobile electronic device is coupled to the docking station 902. It then obtains a content list from the audio/video mobile electronic device 904. The content list may include audio and/or video content stored in the audio/video mobile electronic device. A selection menu is generated from the content list 906 and displayed on an external display device 908. The all-in-one home theater device facilitates user selection of content from the displayed selection menu 910. For instance, the all-in-one home theater device may receive user selections via a remote control device or via the audio/video mobile electronic device itself. Once the user has selected a desired audio/video content, the user-selected content is obtained or retrieved from the mobile electronic device 912. The user-selected video content is displayed on the external display device 914 while the user-selected audio content is played on the integrated speakers.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

One or more of the components, operations, and/or functions illustrated in FIGS. 1-9 may be rearranged and/or combined into a single component, operation, and/or function or separated into several components, operations, and/or functions without departing from the spirit and/or scope of the disclosure. Additional elements, components, operations, and/or functions may also be added without departing from the spirit and/or scope of the disclosure. The apparatus, devices, and/or components illustrated in FIGS. 1, 2, 3, 4, 5 and/or 7 may be configured to perform one or more of the methods, features, and/or operations described in FIGS. 6, 8, and/or 9.

Those of skill would further appreciate that the various illustrative logical blocks, modules, circuits, and algorithm operations described in connection with the examples disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system.

It should be noted that the foregoing configurations are merely examples and are not to be construed as limiting the spirit and/or scope of the disclosure. The description of these examples is intended to be illustrative, and not to limit the scope of the claims. As such, the present teachings can be readily applied to other types of apparatuses and many alternatives, modifications, and variations will be apparent to those skilled in the art.

Thus, while the present invention has been fully described above with particularity and detail, it will be apparent to those of ordinary skill in the art that numerous modifications may be made, without departing from the principles and concepts of the invention as set forth in the claims.

What is claimed is:

1. An all-in-one home theater device, comprising:
an elongated enclosure housing a plurality of speakers;
a mobile device input/output interface including a built-in docking station for receiving a mobile electronic device;
a processing circuit housed within the elongated enclosure and coupled to the mobile device input/output interface and the plurality of speakers, the processing circuit configured to retrieve audio content from a mobile electronic device coupled to the docking station and play the audio content through the plurality of speakers.

2. The device of claim 1, wherein the plurality of speakers are configured to provide a surround sound effect.

3. The device of claim 1, wherein the processing circuit is further configured to display a user interface through an external display device through which content stored in the mobile electronic device can be selected for playback.

4. The device of claim 1, wherein the mobile electronic device includes integrated content storage and playback capabilities.

5. The device of claim 1, wherein the processing circuit is further configured to retrieve audio content information from the mobile electronic device;
generate a menu of the audio content information; and
send the menu to an external display device coupled to the processing circuit.

6. The device of claim 5, wherein the processing circuit is further configured to receive a menu selection identifying a particular audio content;
retrieve the selected audio content from the mobile electronic device; and
play the retrieved audio content through the plurality of speakers.

7. The device of claim 1, wherein the processing circuit is further configured to retrieve video content information from the mobile electronic device;
generate a menu of the video content information;
send the menu to an external display device coupled to the processing circuit;
receive a menu selection identifying a particular video content;
retrieve the selected video content from the mobile electronic device; and
display the retrieved video content through the external display device.

8. The device of claim 1, further comprising:
a remote control configured to communicate with the processing circuit to allow a user to select audio content to be played from the mobile electronic device.

9. The device of claim 8, wherein the remote control is further configured to communicate with the processing circuit to allow the user to select audio content to be stored in the mobile electronic device.

10. The device of claim 8, wherein the remote control is further configured to control the volume for the plurality of speakers.

11. The device of claim 1, further comprising:
a network interface coupled to the processing circuit, wherein the processing circuit is further configured to
receive audio and video content through the network interface;
play the audio content through the plurality of speakers; and
display the video content through the external display device.

12. The device of claim 1 further comprising a media player housed within the elongated enclosure and coupled to the processing circuit, wherein the processing circuit is further configured to
retrieve audio and video content from the media player;
play the audio content through the plurality of speakers; and
display the video content through the external display device.

13. The device of claim 1 wherein the docking station is adjustable between a first concealed position and a second accessible position.

14. A method operational on an all-in-one home theater device having built-in speakers and a docking station for mobile electronic devices, comprising:
retrieving content information from a mobile electronic device coupled to the docking station;
generating a menu of the content information;
sending the menu to an external display device;
receiving a menu selection identifying a selected content;
retrieving the selected content from the mobile electronic device;
displaying a video content portion of the retrieved selected content through the external display device; and
playing an audio content portion of the retrieved selected content through the built-in speakers.

15. The method of claim 14 further comprising:
obtaining audio and video content through a built-in network interface;
playing the audio content through the plurality of speakers; and
displaying the video content through the external display device.

16. The method of claim 14 further comprising:
obtaining audio and video content from a media player;
playing the audio content through the plurality of speakers; and
displaying the video content through the external display device.

17. An all-in-one home theater device, comprising:
means for retrieving content information from a mobile electronic device;
means for generating a menu of the content information;
means for sending the menu to an external display device;
means for receiving a menu selection identifying a selected content;
means for retrieving the selected content from the mobile electronic device; and
means for playing an audio content portion of the retrieved selected content.

18. The device of claim 17 further comprising:
means for obtaining an audio and video content through a built-in network interface; and
means for storing the audio and video content on the mobile electronic device.

19. The device of claim 17 further comprising:
means for obtaining audio and video content from a media player;
means for playing the audio content; and
means for displaying the video content through the external display device.
